(19) United States
(12) Patent Application Publication
(10) Pub. No.: US 2020/0173778 A1
(43) Pub. Date: Jun. 4, 2020

(54) Laser Guide Pipe Fitting Assembly

(71) Applicants: Styles Smith, Neptune Beach, FL (US); Darrell Smith, Neptune Beach, FL (US)

(72) Inventors: Styles Smith, Neptune Beach, FL (US); Darrell Smith, Neptune Beach, FL (US)

(21) Appl. No.: 16/208,711

(22) Filed: Dec. 4, 2018

(51) Int. Cl. G01C 15/00; F16L 5/00

(52) U.S. Cl. CPC G01C 15/002; F16L 5/00

(57) ABSTRACT

A laser guide pipe fitting assembly for accurate hole drilling when laying pipe includes a plurality of pipe fittings, each comprising a cylindrical bushing having a front end, a rear end, and a bushing diameter. The front end has a cavity extending through to proximal the rear end. The cylindrical bushing is configured to fit in an open end of a pipe having an inner diameter and an outer diameter with the bushing diameter substantially conforming to the inner diameter. The cavity is configured to receive a laser pointer. A collar is coupled to the front end of the cylindrical housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art including information disclosed under 37 CFR 1.97 and 1.98.

The disclosure and prior art relates to laser guides and more particularly pertains to a new laser guide for accurate hole drilling when laying pipe.

### BRIEF SUMMARY OF THE INVENTION

An embodiment of the disclosure meets the needs presented above by generally comprising a plurality of pipe fittings, each comprising a cylindrical bushing having a front end, a rear end, and a bushing diameter. The front end has a cavity extending through to proximal the rear end. The cylindrical bushing is configured to fit in an open end of a pipe having an inner diameter and an outer diameter with the bushing diameter substantially conforming to the inner diameter. The cavity is configured to receive a laser pointer. A collar is coupled to the front end of the cylindrical housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a laser guide pipe fitting assembly according to an embodiment of the disclosure.

FIG. 2 is an exploded view of an embodiment of the disclosure.

FIG. 3 is a side elevation view of an embodiment of the disclosure.

FIG. 4 is a cross-sectional view of an embodiment of the disclosure.

FIG. 5 is a front elevation view of an embodiment of the disclosure.

FIG. 6 is a rear elevation view of an embodiment of the disclosure.

FIG. 7 is an in-use view of an embodiment of the disclosure.

### DETAILED DESCRIPTION OF THE INVENTION

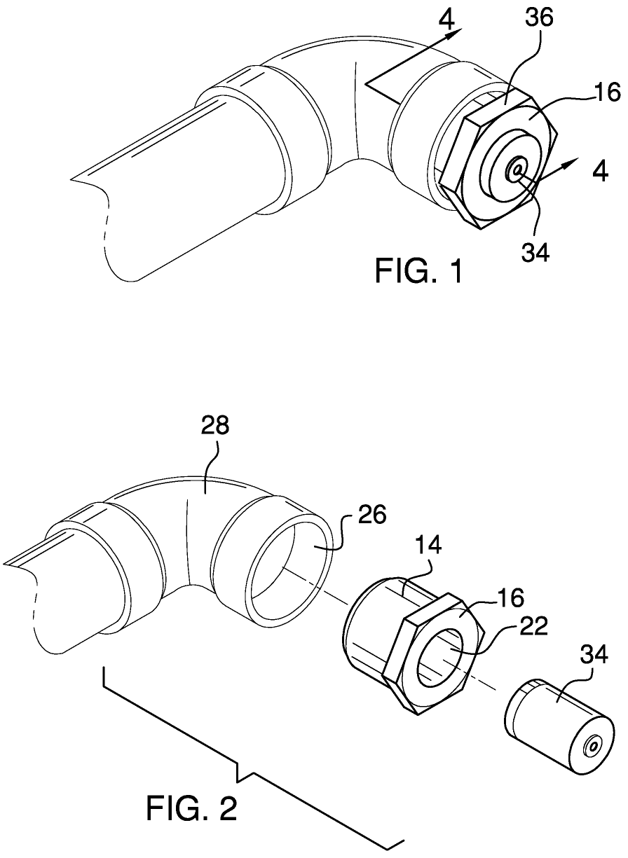

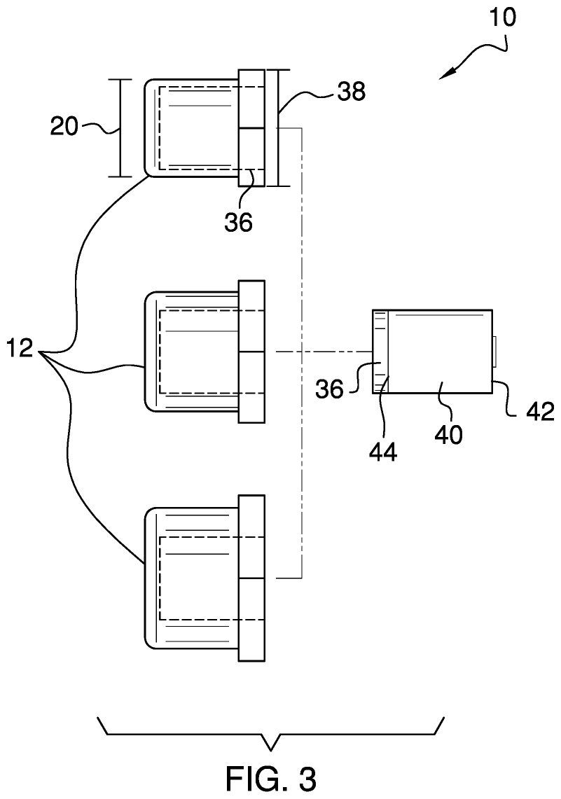

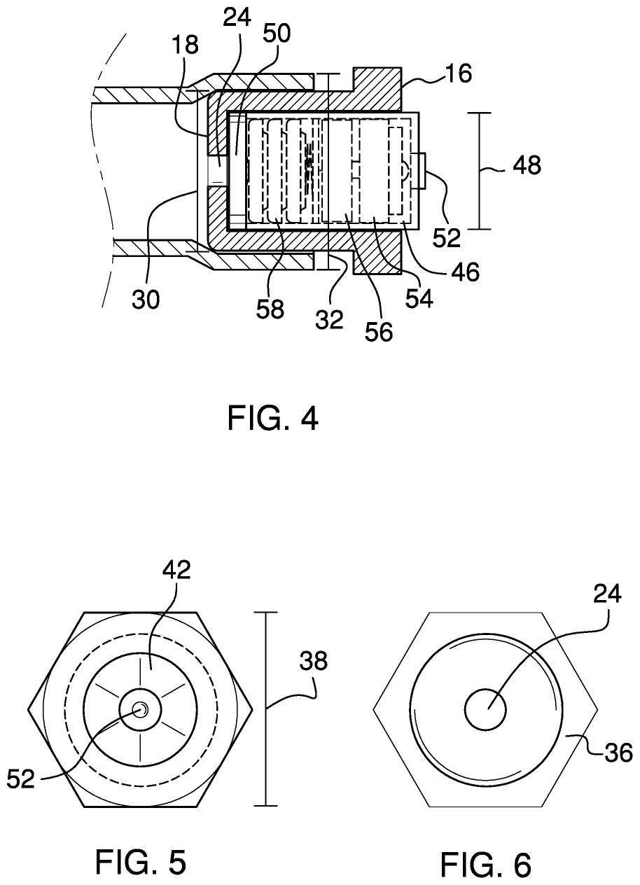

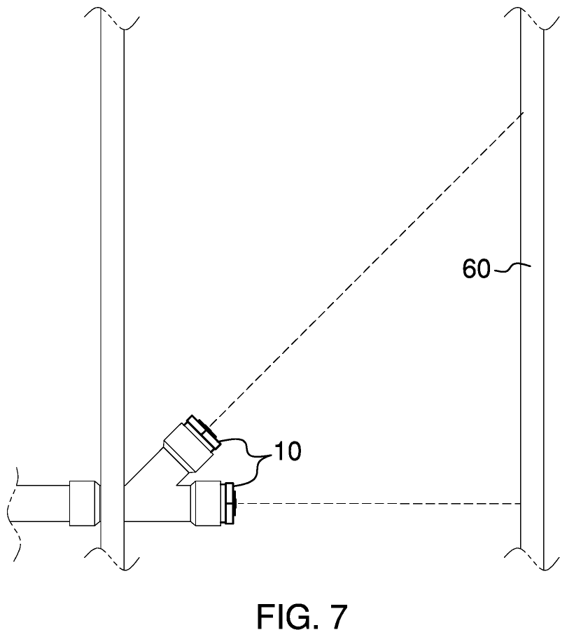

With reference now to the drawings, and in particular to FIGS. 1 through 7 thereof, a new laser guide embodying the principles and concepts of an embodiment of the disclosure and generally designated by the reference numeral 10 will be described.

As best illustrated in FIGS. 1 through 7, the laser guide pipe fitting assembly 10 generally comprises a plurality of pipe fittings 12, each comprising a cylindrical bushing 14 having a front end 16, a rear end 18, and a bushing diameter 20. The front end has a cavity 22 extending through to proximal the rear end 18. The cavity 22 has a cavity diameter 23. The rear end 18 of the cylindrical bushing may have an air aperture 24 extending through to the cavity 22 in order to prevent suction. The cylindrical bushing 14 is configured to fit in an open end 26 of a pipe 28 having an inner diameter 30 and an outer diameter 32. The bushing diameter 20 of a selected pipe fitting of the plurality of pipe fittings 12 substantially conforms to the inner diameter 30 to create a press fit. The cavity 22 is configured to receive a laser pointer 34. A collar 36 is coupled to the front end 16 of the cylindrical bushing. The collar 36 may have a collar diameter 38 greater than the outer diameter 32 of the pipe to allow the selected pipe fitting of the plurality of pipe fittings 12 to be easily removed from the pipe 28. The collar 36 may be faceted to allow for a pair of pliers or a wrench to grip the collar 36 for assisted insertion and removal.

The laser pointer 34 may be included with the laser guide pipe fitting assembly 10. The laser pointer may comprise a laser housing 40 having a front side 42 an open rear side 44, an inside 46, and a laser diameter 48 substantially conforming to the cavity diameter 23. A rear cover 50 is coupled to the laser housing 40 and is selectively engageable with the open rear side 44 to access the inside 46. A lens 52 is coupled through the front side 42 of the laser housing. An LD module 54 is coupled within the laser housing 40 adjacent to the lens 52. An LD driver 56 is coupled within the laser housing 40 adjacent to, and is in operational communication with, the LD module 54. A plurality of batteries 58 is coupled within the laser housing 40 adjacent to, and is in operational communication with, the LD driver 56.

In use, the selected pipe fitting of the plurality of pipe fittings 12 is placed into the open end 26 of the pipe that is being lied. The laser pointer 34 is placed within the cavity 22 and then shines its beam at a joist 60 in a floor or a ceiling, or a stud in a wall. The laser beam thus demonstrates exactly where the pipe 28 will continue and where a hole needs to be made.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A laser guide pipe fitting assembly, the assembly comprising:
a plurality of pipe fittings, each comprising:
a cylindrical bushing having a front end, a rear end, and a bushing diameter, the front end having a cavity extending through to proximal the rear end, the cylindrical bushing being configured to fit in an open end of a pipe having an inner diameter and an outer diameter, the bushing diameter substantially conforming to the inner diameter, the cavity being configured to receive a laser pointer; and
a collar coupled to the cylindrical bushing, the collar being coupled to the front end.

2. The laser guide pipe fitting assembly of claim 1 further comprising the collar having a collar diameter greater than the outer diameter of the pipe.

3. The laser guide pipe fitting assembly of claim 2 further comprising the rear end of the cylindrical bushing having an air aperture extending through to the cavity.

4. The laser guide pipe fitting assembly of claim 2 further comprising the collar being faceted.

5. The laser guide pipe fitting assembly of claim 4 further comprising the collar being hexagonal.

6. The assembly of claim 1, further comprising:
the rear end of the cylindrical bushing having an air aperture extending through to the cavity, the bushing diameter substantially conforming to the inner diameter; and
the collar having a collar diameter greater than the outer diameter of the pipe, the collar being faceted.

7. A laser guide pipe fitting assembly, the assembly comprising:
a laser pointer; and
a plurality of pipe fittings, each comprising:
a cylindrical bushing having a front end, a rear end, and a bushing diameter, the front end having a cavity extending through to proximal the rear end, the cavity having a cavity diameter, the cylindrical bushing being configured to fit in an open end of a pipe having an inner diameter and an outer diameter, the bushing diameter substantially conforming to the inner diameter, the cavity receiving the laser pointer; and
a collar coupled to the cylindrical bushing, the collar being coupled to the front end.

8. A laser guide pipe fitting assembly, the assembly comprising:
a laser pointer, the laser pointer comprising:
a laser housing, the laser housing having a front side, an open rear side, an inside, and a laser diameter;
a rear cover coupled to the laser housing, the rear cover being selectively engageable with the open rear side;
a lens coupled to the laser housing, the lens being coupled through the front side;
an LD module coupled within the laser housing, the LD module being coupled adjacent to the lens;
an LD driver coupled within the laser housing, the LD driver being coupled adjacent to, and in operational communication with, the LD module; and
a plurality of batteries coupled within the laser housing, the plurality of batteries being coupled adjacent to, and in operational communication with, the LD driver; and
a plurality of pipe fittings, each comprising:
a cylindrical bushing having a front end, a rear end, and a bushing diameter, the front end having a cavity extending through to proximal the rear end, the cavity having a cavity diameter, the cylindrical bushing being configured to fit in an open end of a pipe having an inner diameter and an outer diameter, the bushing diameter substantially conforming to the inner diameter, the cavity receiving the laser pointer; and
a collar coupled to the cylindrical bushing, the collar being coupled to the front end.

9. The assembly of claim 8, further comprising:
the cavity diameter substantially conforming to the laser diameter, the rear end of the cylindrical bushing having an air aperture extending through to the cavity; and
the collar having a collar diameter greater than the outer diameter of the pipe, the collar being faceted.
